(19) United States
(12) Patent Application Publication
(10) Pub. No.: US 2025/0138294 A1
(43) Pub. Date: May 1, 2025

(54) MODE CONVERSION APPARATUS BASED ON OFF-AXIS MIRROR

(71) Applicant: Korea Astronomy and Space Science Institute, Daejeon (KR)

(72) Inventors: Ho Jae AHN, Yongin-si (KR); Soo Jong PARK, Seoul (KR); Seung Hyuk CHANG, Seoul (KR); Su Min LEE, Suwon-si (KR); Chang-Hee KIM, Siheung-si (KR); Sung Ho LEE, Gyeryong-si (KR); Yun Jong KIM, Daejeon (KR)

(73) Assignee: Korea Astronomy and Space Science Institute, Daejeon (KR)

(21) Appl. No.: 18/819,637

(22) Filed: Aug. 29, 2024

(30) Foreign Application Priority Data
Oct. 31, 2023 (KR) 10-2023-0148244

(51) Int. Cl. G02B 17/06

(52) U.S. Cl. CPC G02B 17/06

(57) ABSTRACT

A mode conversion apparatus includes a first freeform-surface mirror to reflect incident light provided from a front-end optical system and output the reflected light in a first direction, and a second freeform-surface mirror to reflect the reflected light and output mode-converted light in a second direction where surface shapes of the first and second mirrors are determined based on a freeform-surface coefficient determined by at least five optical parameters of a distance from the first mirror to a confocal point of the first mirror and the second mirror, a distance from the confocal point to the second mirror, a distance from a waist of the incident light to the first mirror, a distance from the second mirror to a waist of the mode-converted light, and an incident angle of the incident light for the first mirror and an incident angle of the reflected light for the second mirror.

### CROSS-REFERENCE TO RELATED APPLICATION

This application claims priority to Korean Patent Application No. 10-2023-0148244, filed on Oct. 31, 2023 in the Korean Intellectual Property Office, the disclosure of which is incorporated herein by reference.

### BACKGROUND OF THE DISCLOSURE

### Field of the Disclosure

The present disclosure relates to a mode conversion apparatus based on an off-axis mirror, and more particularly to a technical idea of optimizing the optical design of a polarization-preserving off-axis reflective laser mode conversion apparatus.

### Description of the Related Art

The characteristics of a laser beam can be described in terms of mode, and apparatuses that use lasers often have an appropriate input mode determined depending on the purpose of the experiment or the characteristics of the apparatuses themselves.

Therefore, a mode conversion apparatus capable of converting a laser mode to suit each apparatus is required to increase the efficiency of a laser beam.

A mode conversion apparatus is also called a mode-matching telescope because its structure is similar to that of a telescope. A refractive type is preferred such that the straightness of light can be utilized as is, but, when multiple wavelengths are used and it is difficult to secure a sufficient distance or when scattered light is extremely suppressed, a mode-matching telescope may be configured in a reflective type.

However, in an on-axis optical system used in a reflective astronomical telescope, the central portion of a primary mirror is obscured by a secondary mirror. Specifically, in many laser systems using Gaussian beams in TEM00 mode, most of the light intensity is concentrated in the central part of an optical path, so shielding the central portion results in significant light loss.

Therefore, a reflective laser mode-matching telescopes should be configured with an off-axis optical system to avoid shielding.

Taking an astronomical telescope as an example, a typical off-axis optical system exhibits linear astigmatism that does not appear in an on-axis optical system. This has a much greater impact on image quality than the Seidel aberrations observed in an on-axis optical system.

Such linear astigmatism does not appear in the center of the field of view, so when an off-axis optical system is applied to a laser system, it is free from linear astigmatism, but there is a problem in that it is not free from polarization.

### RELATED ART DOCUMENT

### Patent Document

(Patent Document 1) Korean Patent No. 10-1789383, entitled “OFF-AXIS OPTIC DEVICE”.

### SUMMARY OF THE DISCLOSURE

Therefore, the present disclosure has been made in view of the above problems, and it is an object of the present disclosure to provide a mode conversion apparatus capable of converting the mode of incident light provided from a laser optical system while preserving polarization by applying a linear astigmatism free condition.

It is another object of the present disclosure to provide a mode conversion apparatus capable of optimally designing optical parameters for changing the mode of laser incident light.

It is still another object of the present disclosure to provide a mode conversion apparatus capable of suppressing the occurrence of a higher order mode (HOM) through the freeform-surface optimization of the freeform-surface mirror.

It is yet another object of the present disclosure to provide a mode conversion apparatus that can be applied to a mode conversion apparatus for squeezed vacuum light of quantum state, a gravitational wave detection apparatus, a laser interception apparatus for military purposes, and other apparatuses utilizing a resonator or an optical fiber.

In accordance with an aspect of the present disclosure, the above and other objects can be accomplished by the provision of a mode conversion apparatus, including: a first freeform-surface mirror configured to reflect incident light provided from a front-end optical system and output the reflected light in a first direction; and a second freeform-surface mirror configured to reflect the reflected light and output mode-converted light in a second direction corresponding to a rear-end optical system, wherein surface shapes of the first and second freeform-surface mirrors are determined based on a freeform-surface coefficient determined by at least five optical parameters of a distance from the first freeform-surface mirror to a confocal point of the first freeform-surface mirror and the second freeform-surface mirror, a distance from the confocal point to the second freeform-surface mirror, a distance from a waist of the incident light to the first freeform-surface mirror, a distance from the second freeform-surface mirror to a waist of the mode-converted light, and an incident angle of the incident light for the first freeform-surface mirror and an incident angle of the reflected light for the second freeform-surface mirror.

According to an aspect, a distance from the first freeform-surface mirror to the confocal point may be 370.54 mm, and a distance from the confocal point to the second freeform-surface mirror may be 61.5472 mm.

According to an aspect, a distance from the waist of the incident light to the first freeform-surface mirror may be 236.3541 mm, and a distance from the second freeform-surface mirror to the waist of the mode-converted light may be 1471.4665 mm.

According to an aspect, an incident angle of the incident light for the first freeform-surface mirror may be 14.92°, and an incident angle of the reflected light for the second freeform-surface mirror may be 24.46°.

According to an aspect, a semi-major axis of the first freeform-surface mirror may be 280.6708 mm, and a semi-major axis of the second freeform-surface mirror may be 710.1308 mm.

According to an aspect, an off-axis angle of the first freeform-surface mirror may be 50.3142°, and an off-axis angle of the second freeform-surface mirror may be 22.7024°.

According to an aspect, a conic constant of the first freeform-surface mirror may be −0.1119, and a conic constant of the second freeform-surface mirror may be −1.1510.

According to an aspect, the surface shapes of the first and second freeform-surface mirrors may be determined through Equation 1 below defining a freeform-surface based on the freeform-surface coefficient (cₖ; where k is a positive integer):

$$z ( x , y ) = {\sum }_{m = 0}^{5} {\sum }_{n = 0}^{m} {c}_{k} {x}^{m - n} {y}^{n} ; k = \frac{m ( m + 1 )}{2} + n \qquad [ Equation 1 ]$$

According to an aspect, when the freeform-surface coefficient is c₃, the surface of the first freeform-surface mirror may be determined as −1.78473E-03 mm⁻¹, and the surface of the second freeform-surface mirror may be determined as −4.75086E-03 mm⁻¹, when the freeform-surface coefficient is c₅, the surface of the first freeform-surface mirror may be determined as −1.66642E-03 mm⁻¹, and the surface of the second freeform-surface mirror may be determined as −3.93635E-03 mm⁻¹, when the freeform-surface coefficient is c₇, the surface of the first freeform-surface mirror may be determined as −3.44799E-07 mm⁻², and the surface of the second freeform-surface mirror may be determined as −1.54869E-05 mm⁻², when the freeform-surface coefficient is c₉, the surface of the first freeform-surface mirror may be determined as −3.21942E-07 mm⁻², and the surface of the second freeform-surface mirror may be determined as −1.28318E-05 mm⁻², and when the freeform-surface coefficient is c₁₀, the surface of the first freeform-surface mirror may be determined as −5.82799E-10 mm⁻³, and the surface of the second freeform-surface mirror may be determined as 2.75914E-07 mm⁻³.

According to an aspect, when the freeform-surface coefficient is c₁₂, a surface of the first freeform-surface mirror may be determined as −4.11544E-10 mm⁻³, and a surface of the second freeform-surface mirror may be determined as 3.57567E-07 mm⁻³, when the freeform-surface coefficient is c₁₄, the surface of the first freeform-surface mirror may be determined as 2.49032E-10 mm⁻³, and the surface of the second freeform-surface mirror may be determined as 1.21805E-07 mm⁻³, when the freeform-surface coefficient is c₁₆, the surface of the first freeform-surface mirror may be determined as 3.45330E-10 mm⁻⁴, and the surface of the second freeform-surface mirror may be determined as −4.15260E-07 mm⁻⁴, when the freeform-surface coefficient is c₁₈, the surface of the first freeform-surface mirror may be determined as 3.67005E-10 mm⁻⁴, and the surface of the second freeform-surface mirror may be determined as −2.96124E-07 mm⁻⁴, and when the freeform-surface coefficient is c₂₀, the surface of the first freeform-surface mirror may be determined as 9.93976E-11 mm⁻⁴, and the surface of the second freeform-surface mirror may be determined as −1.07659E-07 mm⁻⁴.

According to an aspect, the front-end optical system may output the incident light having a waist of 19.79 microns at a point of 370.54 mm away from the first freeform-surface mirror against a direction of travel of the incident light.

According to an aspect, the second freeform-surface mirror may output the mode-converted light having a waist of 344 microns at a point of 1474.4665 mm away along a direction of travel of the mode-converted light from the second freeform-surface mirror.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 illustrates a mode conversion apparatus based on an off-axis mirror according to an embodiment; and

FIGS. 2A and 2B illustrate an embodiment of optimally designing a freeform-surface coefficient applied to the mode conversion apparatus based on an off-axis mirror according to an embodiment.

### DETAILED DESCRIPTION OF THE DISCLOSURE

The embodiments will be described in detail herein with reference to the drawings.

However, it should be understood that the present disclosure is not limited to the embodiments according to the concept of the present disclosure, but includes changes, equivalents, or alternatives falling within the spirit and scope of the present disclosure.

In the following description of the present disclosure, a detailed description of known functions and configurations incorporated herein will be omitted when it may make the subject matter of the present disclosure unclear.

The terms used in the specification are defined in consideration of functions used in the present disclosure, and can be changed according to the intent or conventionally used methods of clients, operators, and users. Accordingly, definitions of the terms should be understood on the basis of the entire description of the present specification.

In description of the drawings, like reference numerals may be used for similar elements

The singular expressions in the present specification may encompass plural expressions unless clearly specified otherwise in context.

In this specification, expressions such as “A or B” and “at least one of A and/or B” may include all possible combinations of the items listed together.

Expressions such as “first” and “second” may be used to qualify the elements irrespective of order or importance, and are used to distinguish one element from another and do not limit the elements.

It will be understood that when an element (e.g., first) is referred to as being “connected to” or “coupled to” another element (e.g., second), it may be directly connected or coupled to the other element or an intervening element (e.g., third) may be present.

As used herein, “configured to” may be used interchangeably with, for example, “suitable for”, “ability to”, “changed to”, “made to”, “capable of”, or “designed to” in terms of hardware or software.

In some situations, the expression “device configured to” may mean that the device “may do ˜” with other devices or components.

For example, in the sentence “processor configured to perform A, B, and C”, the processor may refer to a general purpose processor (e.g., CPU or application processor) capable of performing corresponding operation by running a dedicated processor (e.g., embedded processor) for performing the corresponding operation, or one or more software programs stored in a memory device.

In addition, the expression “or” means “inclusive or” rather than “exclusive or”.

That is, unless otherwise mentioned or clearly inferred from context, the expression “uses a or b” means any one of natural inclusive permutations.

Terms, such as “unit” or “module”, etc., should be understood as a unit that processes at least one function or operation and that may be embodied in a hardware manner, a software manner, or a combination of the hardware manner and the software manner.

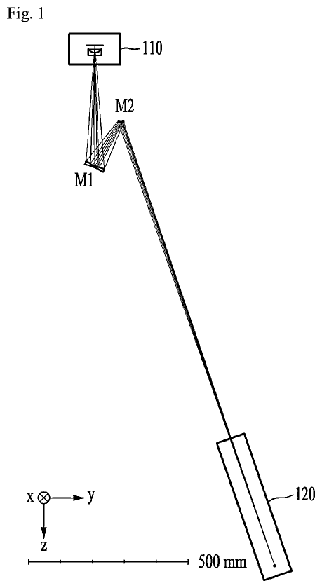

FIG. 1 illustrates a mode conversion apparatus based on an off-axis mirror according to an embodiment.

Referring to FIG. 1, the mode conversion apparatus according to an embodiment may convert the mode of incident light provided from a laser optical system while preserving polarization by applying a linear astigmatism free condition.

In addition, the mode conversion apparatus may be designed to optimize optical parameters for changing the mode of laser incident light.

Specifically, an off-axis optical system has more variables used when designing, compared to an on-axis optical system, and has a problem of high design difficulty due to linear astigmatism that does not appear in an on-axis optical system and changes in polarization characteristics.

However, the off-axis optical system can derive conditions, under which linear astigmatism is eliminated, based on the geometric optics theory, and it can be proven that polarization is preserved under these conditions.

Accordingly, the mode conversion apparatus may derive and optimize optical parameters based on a formula applying the linear astigmatism free condition. Accordingly, an off-axis reflective laser mode conversion technology with preserved polarization may be implemented.

Specifically, in the optical design process of the present disclosure to implement a mode conversion apparatus, an optical design that has theoretically equivalent performance to a refractive-type optical system, is based on formulas unlike a design based on optimization of an existing optical program and meets the desired performance conditions (including volume) can be immediately obtained and applied. In particular, the present disclosure can suppress the occurrence of a higher order mode (HOM) by optimizing a mirror surface using a freeform-surface after a basic design using a conic curve as a mirror surface.

Meanwhile, the mode conversion apparatus may be applied to a mode conversion apparatus for squeezed vacuum light, a gravitational wave detection apparatus, a laser interception apparatus for military purposes, and other apparatuses utilizing a resonator or an optical fiber.

Specifically, quantum-squeezing level in the mode conversion apparatus for squeezed vacuum light is greatly affected particularly by mode matching.

In squeezed vacuum light, there is loss at the quantum-squeezing level in addition to the power loss caused by different modes when mode matching is not done properly, and when a spherical/normal aspherical lens is used, a higher order mode is created, which also causes loss.

In other words, the mode conversion of squeezed vacuum light is a factor that greatly affects the efficiency of the entire experiment, and since the number of photons is not large, backscattering by the lens surface can also affect performance. Accordingly, it is advantageous to configure the optical system as an off-axis optical system.

That is, the mode conversion apparatus is an optical system that can encompass all the characteristics of squeezed vacuum light described above and can implement mode conversion characteristics optimized for squeezed vacuum light.

A gravitational wave detection apparatus is one of the most sensitive measuring instruments available to mankind. Minimization of mode matching loss is mentioned as one of the main challenges that must be solved to further improve the sensitivity of a gravitational wave detection apparatus.

In particular, in the gravitational wave detection apparatus, consideration of higher order modes is beginning, and according to optical theory, this cannot be overcome with existing spherical lenses. This can be overcome by using an aspherical lens, but if two laser beams sharing an optical path have different wavelengths, the problem of chromatic aberration cannot be avoided, and when squeezed vacuum light is introduced, an off-axis reflection optical system is inevitably preferred due to backscattering as described above.

Therefore, the mode conversion apparatus can be easily applied to the gravitational wave detection apparatus to achieve excellent performance.

A laser interception apparatus for military purposes is an apparatus that damages enemy equipment by concentrating a high-power laser on one point. To focus the laser well without loss of light, appropriate mode conversion (mode matching) is essential, and the apparatus should be easy to move.

Therefore, if a mode conversion apparatus is made in an off-axis manner, higher efficiency can be achieved in a smaller volume, so, if the mode conversion apparatus is applied to a laser interception apparatus for military purposes, higher performance can be achieved compared to existing methods.

Since a general resonator or optical fiber does not operate at all or has low operating efficiency if the mode is not accurate, higher performance can be achieved by applying a mode conversion device that effectively suppresses higher order modes while enabling free space utilization in the resonator or optical fiber.

As shown in FIG. 1, such a mode conversion apparatus may include a first freeform-surface mirror M1 and a second freeform-surface mirror M2.

Specifically, the first freeform-surface mirror M1 according to an embodiment may reflect incident light provided from the front-end optical system 110 and output reflected light in a first direction.

In addition, the second freeform-surface mirror M2 may reflect the reflected light and output mode-converted light (i.e., emitted light) in a second direction corresponding to a rear-end optical system 120.

For example, the front-end optical system 110 may output an incident light with a waist (i.e., focal point) of 19.79 microns at a point of 370.54 mm away from the first freeform-surface mirror M1 against the direction of travel of the incident light.

In addition, the second freeform-surface mirror M2 may output mode-converted light with a waist of 344 microns at a point 1474.4665 mm away from the second freeform-surface mirror M2 along the direction of travel of mode-converted light.

The surface shapes of the first freeform-surface mirror M1 according to an embodiment and the second freeform-surface mirror M2 may be determined based on a freeform-surface coefficient determined by at least five optical parameters among a distance (l₁) from the first freeform-surface mirror M1 to a confocal point of the first freeform-surface mirror M1 and the second freeform-surface mirror M2, a distance (l₂) from the confocal point to the second freeform-surface mirror M2, a distance (l′₁) from a waist (i.e., Input beam waist) of the incident light to the first freeform-surface mirror M1, a distance (l′₂) from the second freeform-surface mirror M2 to a waist (i.e., Output beam waist) of the mode-converted light, an incident angle (i₁) of the incident light for the first freeform-surface mirror M1 and an incident angle (i₂) of the reflected light for the second freeform-surface mirror M2.

Preferably, the surface shapes of the first freeform-surface mirror M1 and the second freeform-surface mirror M2 may be determined through Equation 1 below (i.e., XY polynomial) defining a freeform-surface based on a freeform-surface coefficient (cₖ; where k is a positive integer).

However, in Equation 1 below, the maximum value of m is described as ‘5’, but the maximum value of m is not limited thereto, and may be easily changed to a value of ‘5’ or less or a value of ‘5’ or more (e.g., ‘10’, etc.) depending on design conditions such as the characteristics of mode-converted light.

$$z ( x , y ) = {\sum }_{m = 0}^{5} {\sum }_{n = 0}^{m} {c}_{k} {x}^{m - n} {y}^{n} ; k = \frac{m ( m + 1 )}{2} + n \qquad [ Equation 1 ]$$

In Equation 1 above, the positive direction of the z-axis may be a direction closer to a direction, in which laser light exits, among two directions perpendicular to the center of the mirror, the x-axis direction may be the x-axis direction of FIG. 1, and the y-axis direction may be defined by the right-hand rule.

Specifically, when the freeform-surface coefficient is c₃, the surface of the first freeform-surface mirror M1 may be defined as −1.78473E-03 mm⁻¹, and the surface of the second freeform-surface mirror M2 may be defined as −4.75086E-03 mm⁻¹.

In addition, when the freeform-surface coefficient is c₅, the surface of the first freeform-surface mirror M1 may be defined as −1.66642E-03 mm⁻¹, and the surface of the second freeform-surface mirror M2 may be defined as −3.93635E-03 mm⁻¹.

In addition, when the freeform-surface coefficient is c₇, the surface of the first freeform-surface mirror M1 may be defined as −3.44799E-07 mm⁻², and the surface of the second freeform-surface mirror M2 may be defined as −1.54869E-05 mm⁻².

In addition, when the freeform-surface coefficient is c₉, the surface of the first freeform-surface mirror M1 may be defined as −3.21942E-07 mm⁻², and the surface of the second freeform-surface mirror M2 may be defined as −1.28318E-05 mm⁻².

In addition, when the freeform-surface coefficient is c₁₂, the surface of the first freeform-surface mirror M1 may be defined as −4.11544E-10 mm⁻³, and the surface of the second freeform-surface mirror M2 may be defined as 3.57567E-07 mm⁻³.

In addition, when the freeform-surface coefficient is c₁₄, the surface of the first freeform-surface mirror M1 may be defined as 2.49032E-10 mm⁻³, and the surface of the second freeform-surface mirror M2 may be defined as 1.21805E-07 mm⁻³.

In addition, when the freeform-surface coefficient is c₁₆, the surface of the first freeform-surface mirror M1 may be defined as 3.45330E-10 mm⁻⁴, and the surface of the second freeform-surface mirror M2 may be defined as −4.15260E-07 mm⁻⁴.

In addition, when the freeform-surface coefficient is c₁₈, the surface of the first freeform-surface mirror M1 may be defined as 3.67005E-10 mm⁻⁴, and the surface of the second freeform-surface mirror M2 may be defined as −2.96124E-07 mm⁻⁴.

In addition, when the freeform-surface coefficient is c₂₀, the surface of the first freeform-surface mirror M1 may be defined as 9.93976E-11 mm⁻⁴, and the surface of the second freeform-surface mirror M2 may be defined as −1.07659E-07 mm⁻⁴.

Meanwhile, the mode conversion apparatus may optimally design optical parameters to convert incident light into mode-converted light (emitted light). Here, the optical parameters may include the distance (l₁) from the first freeform-surface mirror M1 to the confocal point, the distance (l₂) from the confocal point to the second freeform-surface mirror M2, the distance (l′₁) from the waist of the incident light to the first freeform-surface mirror M1, the distance (l′₂) from the second freeform-surface mirror M2 to the waist of the mode-converted light, the incident angle (i₁) of incident light for the first freeform-surface mirror M1 and the incident angle (i₂) of reflected light for the second freeform-surface mirror M2, a semi-major axis (a₁) of the first freeform-surface mirror M1, a semi-major axis (a₂) of the second freeform-surface mirror M2, an off-axis angle (θ₁) of the first freeform-surface mirror M1, an off-axis angle (θ₂) of the second freeform-surface mirror M2, a conic constant (K₁) of the first freeform-surface mirror M1 and a conic constant (K₂) of the second freeform-surface mirror M2.

Specifically, the distance (l₁) from the first freeform-surface mirror M1 to the confocal point may be 370.54 mm, and the distance (l₂) from the confocal point to the second freeform-surface mirror M2 may be 61.5472 mm.

In addition, the distance (l′₁) from the waist of the incident light to the first freeform-surface mirror M1 may be 236.3541 mm, and the distance (l′₂) from the second freeform-surface mirror M2 to the waist of the mode-converted light may be 1471.4665 mm.

In addition, the incident angle (i₁) of incident light for the first freeform-surface mirror M1 may be 14.92°, and the incident angle (i₂) of reflected light for the second freeform-surface mirror M2 may be 24.46°.

In addition, the semi-major axis (a₁) of the first freeform-surface mirror M1 may be 280.6708 mm, and the semi-major axis (a₂) of the second freeform-surface mirror M2 may be 710.1308 mm.

In addition, the off-axis angle (θ₁) of the first freeform-surface mirror M1 may be 50.3142°, and the off-axis angle (θ₂) of the second freeform-surface mirror M2 may be 22.7024°.

In addition, the conic constant (K₁) of the first freeform-surface mirror M1 may be −0.1119, and the conic constant (K₂) of the second freeform-surface mirror M2 may be −1.1510.

Meanwhile, the mode conversion apparatus may further include a first plane mirror provided between the front-end optical system 110 and the first freeform-surface mirror M1 to reflect incident light in the direction where the first freeform reflector (M1) is located; and a second plane mirror provided between the second freeform-surface mirror M2 and the rear-end optical system 120 to reflect mode-converted light (i.e., emitted light) in the direction where the second freeform-surface mirror M2 is located.

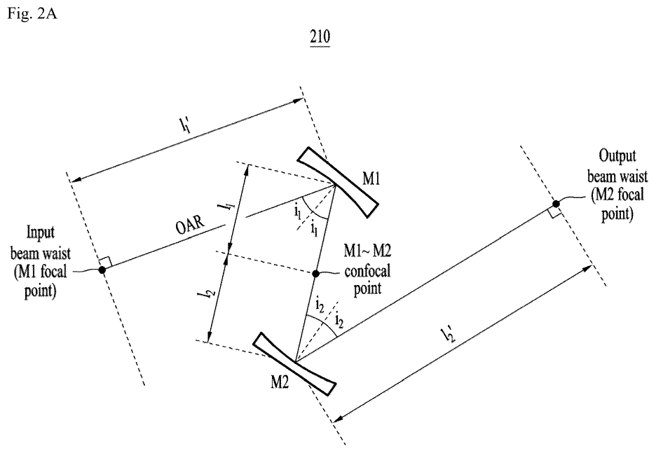

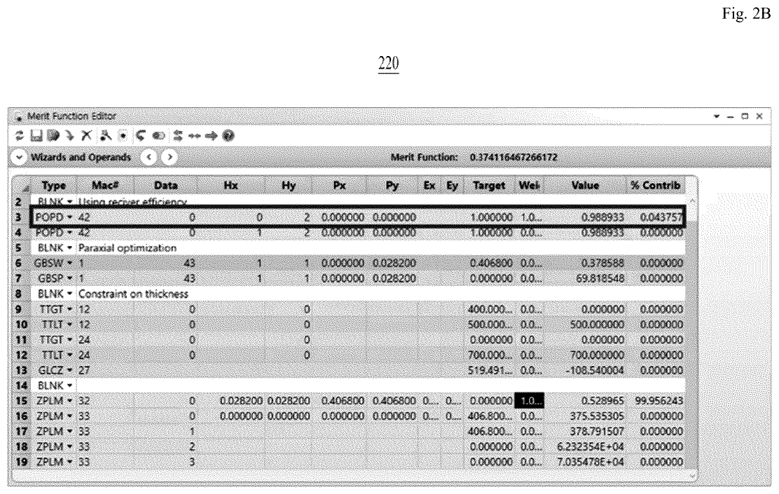

FIGS. 2A and 2B illustrate an embodiment of optimally designing a freeform-surface coefficient applied to the mode conversion apparatus based on an off-axis mirror according to an embodiment.

Referring to FIGS. 2A and 2B, a freeform-surface coefficient (cₖ) according to an embodiment may be determined based on a distance (l₁) from a first freeform-surface mirror M1 to a confocal point (i.e., M1-M2 confocal point), a distance (l₂) from the confocal point to a second freeform-surface mirror M2, a distance (l′₁) from the waist (i.e., Input beam waist) of incident light to the first freeform-surface mirror M1, a distance (l′₂) from the second freeform-surface mirror M2 to the waist (i.e., Output beam waist) of mode-converted light, an incident angle (i₁) of incident light for the first freeform-surface mirror M1 and an incident angle (i₂) of reflected light for the second freeform-surface mirror M2, shown in reference numeral 210.

Hereinafter, a method of optimizing the freeform-surface coefficient (cₖ) according to an embodiment is described.

Specifically, the method of optimizing the freeform-surface coefficient (cₖ) according to an embodiment may determine the six optical parameters (l₁, l₂, l′₁, l′₂, i₁ and i₂) described above.

For example, the distance (l₁, l₂) from the freeform-surface mirror M1, M2 to the confocal point may be replaced with the magnification, m=(l₁/l′₁)×(l₂/l′₂), and a distance (l₁+l₂) between the two freeform-surface mirrors M1 and M2. As a more particular example, the magnification (m) may be 17.6643, and the distance (l₁+l₂) between the two freeform-surface mirrors M1 and M2 may be 164.4745 mm.

According to an aspect, the method of optimizing the freeform-surface coefficient (cₖ) according to an embodiment may determine five optical parameters among six optical parameters (l₁, l₂, l′₁, l′₂, i₁ and i₂), and may determine the remaining 1 optical parameter by applying the determined five optical parameters to Equation 2 below:

$$\frac{{1}_{} + {1}_{}}{{1}_{}} tan {i}_{1} = \frac{{2}_{} + {2}_{}}{{2}_{}} tan {i}_{2} \qquad [ Equation 2 ]$$

Next, the method of optimizing the freeform-surface coefficient (cₖ) according to an embodiment may determine freeform parameters, a1, a2, a3 and a4, by applying the determined six optical parameters (l₁, l₂, l′₁, l′₂, i₁ and i₂) to Equation 3 below expressing the height according to the position of the mirror as a polynomial:

$$z = {a}_{1} {x}^{2} + {a}_{2} {y}^{2} + {a}_{3} {y}^{\tilde{3}} + {a}_{4} {xy}^{2} + O ( {x}^{{n}_{x}} {y}^{{n}_{y}} ) , \qquad [ Equation 3 ]$$

$${a}_{1} = \frac{{( 1 + K {sin}^{2} {θ}_{0} )}^{\frac{3}{2}}}{R} ,$$

$${a}_{2} = \frac{{( 1 + K {sin}^{2} {θ}_{0} )}^{\frac{1}{2}}}{R} ,$$

$${a}_{3} = \frac{K sin 2 {{θ}_{0} ( 1 + K {sin}^{2} {θ}_{0} )}^{2}}{4 {R}^{2}} ,$$

$${a}_{4} = \frac{K sin 2 {θ}_{0} ( 1 + K {sin}^{2} {θ}_{0} )}{4 {R}^{2}} ,$$

where K is determined by

$$ϵ = \frac{c}{2 a} = \frac{\sqrt{{l}^{2} + {l}^{′ 2} - 2 {𝒰}^{′} cos ( 2 l )}}{l + {l}^{′}} , and$$

$${θ}_{0} = {sin}^{- 1} ( \frac{sin ( i )}{ϵ} ) .$$

Next, the method of optimizing the freeform-surface coefficient (cₖ) according to an embodiment may define and optimize a merit function by inputting the determined freeform parameter into an optical design program (e.g., ZEMAX, etc.), as shown in reference numeral 220.

For example, the method of optimizing the freeform-surface coefficient (cₖ) according to an embodiment may include a process of optimizing to increase coupling calculated through the POPD function that calculates the coupling of a Gaussian beam based on an optical design program increases, i.e., to match the characteristics of mode-converted light.

Next, the method of optimizing the freeform-surface coefficient (cₖ) according to an embodiment may obtain optimized values of a freeform-surface coefficient (cₖ) from the optical design program as a result of the optimization process of the merit function.

More specifically, the optimized values of the freeform-surface coefficient (cₖ) according to an embodiment may be derived as shown in Table 1 below.

TABLE 1

| Freeform-surface | First freeform-surface | Second freeform-surface |
|---|---|---|
| coefficient | mirror M1 | mirror M2 |
| c₀[mm] | 0 | 0 |
| c₁[ ] | 0 | 0 |
| c₂[ ] | 0 | 0 |
| C₃[mm⁻¹] | −1.78473E−03 | −4.75086E−03 |
| C₄[mm⁻¹] | 0.00000E+00 | 0.00000E+00 |
| C₅[mm⁻¹] | −1.66642E−03 | −3.93635E−03 |
| C₆[mm⁻²] | 0.00000E+00 | 0.00000E+00 |
| C₇[mm⁻²] | −3.44799E−07 | −1.54869E−05 |
| C₈[mm⁻²] | 0.00000E+00 | 0.00000E+00 |
| C₉[mm⁻²] | −3.21942E−07 | −1.28318E−05 |
| C₁₀[mm⁻³] | −5.82799E−10 | 2.75914E−07 |
| C₁₁[mm⁻³] | 0.00000E+00 | 0.00000E+00 |
| C₁₂[mm⁻³] | −4.11544E−10 | 3.57567E−07 |
| C₁₃[mm⁻³] | 0.00000E+00 | 0.00000E+00 |
| C₁₄[mm⁻³] | 2.49032E−10 | 1.21805E−07 |
| C₁₅[mm⁻⁴] | 0.00000E+00 | 0.00000E+00 |
| C₁₆[mm⁻⁴] | 3.45330E−10 | −4.15260E−07 |
| C₁₇[mm⁻⁴] | 0.00000E+00 | 0.00000E+00 |
| C₁₈[mm⁻⁴] | 3.67005E−10 | −2.96124E−07 |
| C₁₉[mm⁻⁴] | 0.00000E+00 | 0.00000E+00 |
| C₂₀[mm⁻⁴] | 9.93976E−11 | −1.07659E−07 |

Ultimately, the present disclosure can provide a mode conversion apparatus capable of converting the mode of incident light provided from a laser optical system while preserving polarization by applying a linear astigmatism free condition.

In addition, the present disclosure can provide a mode conversion apparatus capable of optimally designing optical parameters for changing the mode of laser incident light.

In addition, the present disclosure can provide a mode conversion apparatus capable of suppressing the occurrence of a higher order mode (HOM) through the freeform-surface optimization of the freeform-surface mirror.

Further, the present disclosure can provide a mode conversion apparatus that is applicable to a mode conversion apparatus for squeezed vacuum light, a gravitational wave detection apparatus, a laser interception apparatus for military purposes, and other apparatuses utilizing a resonator or an optical fiber.

According to an embodiment, a mode conversion apparatus can convert the mode of incident light provided from a laser optical system while preserving polarization by applying a linear astigmatism free condition.

According to an embodiment, the mode conversion apparatus can optimally design optical parameters for changing the mode of laser incident light.

According to an embodiment, the mode conversion apparatus can suppress the occurrence of a higher order mode (HOM) through the freeform-surface optimization of the freeform-surface mirror.

According to an embodiment, the mode conversion apparatus can be easily applied to a mode conversion apparatus for squeezed vacuum light, a gravitational wave detection apparatus, a laser interception apparatus for military purposes, and other apparatuses utilizing a resonator or an optical fiber.

Although the present disclosure has been described with reference to limited embodiments and drawings, it should be understood by those skilled in the art that various changes and modifications may be made therein. For example, the described techniques may be performed in a different order than the described methods, and/or components of the described systems, structures, devices, circuits, etc., may be combined in a manner that is different from the described method, or appropriate results may be achieved even if replaced by other components or equivalents.

Therefore, other embodiments, other examples, and equivalents to the claims are within the scope of the following claims.

### DESCRIPTION OF SYMBOLS

110: front-end optical system
120: rear-end optical system
M1: first freeform-surface mirror
M2: second freeform-surface mirror

What is claimed is:

1. A mode conversion apparatus, comprising:
a first freeform-surface mirror configured to reflect incident light provided from a front-end optical system and output the reflected light in a first direction; and
a second freeform-surface mirror configured to reflect the reflected light and output mode-converted light in a second direction corresponding to a rear-end optical system,
wherein surface shapes of the first and second freeform-surface mirrors are determined based on a freeform-surface coefficient determined by at least five optical parameters of a distance from the first freeform-surface mirror to a confocal point of the first freeform-surface mirror and the second freeform-surface mirror, a distance from the confocal point to the second freeform-surface mirror, a distance from a waist of the incident light to the first freeform-surface mirror, a distance from the second freeform-surface mirror to a waist of the mode-converted light, and an incident angle of the incident light for the first freeform-surface mirror and an incident angle of the reflected light for the second freeform-surface mirror.

2. The mode conversion apparatus according to claim 1, wherein a distance from the first freeform-surface mirror to the confocal point is 370.54 mm, and a distance from the confocal point to the second freeform-surface mirror is 61.5472 mm.

3. The mode conversion apparatus according to claim 1, wherein a distance from the waist of the incident light to the first freeform-surface mirror is 236.3541 mm, and a distance from the second freeform-surface mirror to the waist of the mode-converted light is 1471.4665 mm.

4. The mode conversion apparatus according to claim 1, wherein an incident angle of the incident light for the first freeform-surface mirror is 14.92°, and an incident angle of the reflected light for the second freeform-surface mirror is 24.46°.

5. The mode conversion apparatus according to claim 1, wherein a semi-major axis of the first freeform-surface mirror is 280.6708 mm, and a semi-major axis of the second freeform-surface mirror is 710.1308 mm.

6. The mode conversion apparatus according to claim 1, wherein an off-axis angle of the first freeform-surface mirror is 50.3142°, and an off-axis angle of the second freeform-surface mirror is 22.7024°.

7. The mode conversion apparatus according to claim 1, wherein a conic constant of the first freeform-surface mirror is −0.1119, and a conic constant of the second freeform-surface mirror is −1.1510.

8. The mode conversion apparatus according to claim 1, wherein the surface shapes of the first and second freeform-surface mirrors are determined through Equation 1 below defining a freeform-surface based on the freeform-surface coefficient (cₖ; where k is a positive integer):
$$z ( x , y ) = {\sum }_{m = 0}^{5} {\sum }_{n = 0}^{m} {c}_{k} {x}^{m - n} {y}^{n} ; k = \frac{m ( m + 1 )}{2} + n \qquad [ Equation 1 ]$$

9. The mode conversion apparatus according to claim 8, wherein when the freeform-surface coefficient is c₃, the surface of the first freeform-surface mirror is determined as −1.78473E-03 mm⁻¹, and the surface of the second freeform-surface mirror is determined as −4.75086E-03 mm⁻¹,
when the freeform-surface coefficient is c₅, the surface of the first freeform-surface mirror is determined as −1.66642E-03 mm⁻¹, and the surface of the second freeform-surface mirror is determined as −3.93635E-03 mm⁻¹,
when the freeform-surface coefficient is c₇, the surface of the first freeform-surface mirror is determined as −3.44799E-07 mm⁻², and the surface of the second freeform-surface mirror is determined as −1.54869E-05 mm⁻²,
when the freeform-surface coefficient is c₉, the surface of the first freeform-surface mirror is determined as −3.21942E-07 mm⁻², and the surface of the second freeform-surface mirror is determined as −1.28318E-05 mm⁻², and
when the freeform-surface coefficient is c₁₀, the surface of the first freeform-surface mirror is determined as −5.82799E-10 mm⁻³, and the surface of the second freeform-surface mirror is determined as 2.75914E-07 mm⁻³.

10. The mode conversion apparatus according to claim 8, wherein when the freeform-surface coefficient is c₁₂, a surface of the first freeform-surface mirror is determined as −4.11544E-10 mm⁻³, and a surface of the second freeform-surface mirror is determined as 3.57567E-07 mm⁻³;
when the freeform-surface coefficient is c₁₄, the surface of the first freeform-surface mirror is determined as 2.49032E-10 mm⁻³, and the surface of the second freeform-surface mirror is determined as 1.21805E-07 mm⁻³,
when the freeform-surface coefficient is c₁₆, the surface of the first freeform-surface mirror is determined as 3.45330E-10 mm⁻⁴, and the surface of the second freeform-surface mirror is determined as −4.15260E-07 mm⁻⁴,
when the freeform-surface coefficient is c₁₈, the surface of the first freeform-surface mirror is determined as 3.67005E-10 mm⁻⁴, and the surface of the second freeform-surface mirror is determined as −2.96124E-07 mm⁻⁴, and
when the freeform-surface coefficient is c₂₀, the surface of the first freeform-surface mirror is determined as 9.93976E-11 mm⁻⁴, and the surface of the second freeform-surface mirror is determined as −1.07659E-07 mm⁻⁴.

11. The mode conversion apparatus according to claim 1, wherein the front-end optical system outputs the incident light having a waist of 19.79 microns at a point of 370.54 mm away from the first freeform-surface mirror against a direction of travel of the incident light.

12. The mode conversion apparatus according to claim 1, wherein the second freeform-surface mirror outputs the mode-converted light having a waist of 344 microns at a point of 1474.4665 mm away along a direction of travel of the mode-converted light from the second freeform-surface mirror.
